(19) United States
(12) Patent Application Publication
(10) Pub. No.: US 2005/0086098 A1
(43) Pub. Date: Apr. 21, 2005

(54) Task-based methods, systems and computer program products for evaluating performance of service technicians

(76) Inventors: David T. Fulton, Sharpsburg, GA (US); Karene C. Pace, Decatur, GA (US); Michael R. Walker, Stone Mountain, GA (US); Atul Gambhir, Birmingham, AL (US); Jason S. Robbins, Pensacola, FL (US); Deborah A. Childers, Powder Springs, GA (US); James A. Bailey JR., Augusta, GA (US)

Correspondence Address: MYERS BIGEL SIBLEY & SAJOVEC, P.A., P.O. BOX 37428, RALEIGH, NC, 27627, US

(21) Appl. No.: 10/686,416

(22) Filed: Oct. 15, 2003

(51) Int. Cl. G06F 17/60

(52) U.S. Cl. 705/11

(57) ABSTRACT

The performance of a service technician who performs multiple service dispatches is evaluated by comparing the service technician's actual times to perform a series of tasks that make up a dispatch, to planned times for the series of tasks. Statistically derived planned times may be assigned to tasks that make up a dispatch, so that an objective work measurement and evaluation may be provided.

### FIELD OF THE INVENTION

This invention relates to computer systems, methods and computer program products, and more particularly to computer systems, methods and/or computer program products that are used for performance evaluations.

### BACKGROUND OF THE INVENTION

Many business enterprises employ large numbers of service technicians to service the enterprise's equipment and/or the enterprise's customers' equipment in the field. The equipment may include consumer and/or industrial equipment in various industries. For example, a communications service provider may have a large workforce of up to 10,000 or more service technicians who perform service dispatches on equipment over a large geographical area that can serve up to millions or more customers. As such, it may be desirable to measure and assess efficiencies of service technicians' performance on a periodic basis in order to provide metrics and coaching opportunities.

It is known to provide computer-based service technician performance evaluation systems, methods and computer program products. For example, BellSouth Corporation has employed a system, referred to as Integrated Technician Performance 2000 (ITP2000), that measures service technician performance based on a number of completed service dispatches by a service technician. More specifically, ITP2000 generates a service technician ITP score on a monthly basis using the following formula:

$$ITP = \frac{\text{Hours per Dispatch}}{\text{Dispatch Efficiency} \times ( 1 - \text{Total Revisit Rate} )} , \qquad ( 1 )$$

where Hours per Dispatch is equal to the total productive hours in a month divided by the total number of dispatches in a month, Dispatch Efficiency is equal to the total number of completed demand dispatches divided by the total number of dispatches for the month, and the total revisit rate is equal to the total number of the service technician's tasks that had to be revisited divided by the total number of tasks that could qualify for a revisit for a given month.

Accordingly, ITP provides a dispatch-derived measurement method, which bases performance on completed dispatches on a monthly basis. ITP scores may be linked to cost by multiplying a service technician work group ITP score by an effective loaded labor rate. ITP scores also may be used for service technician performance evaluations. Moreover, ITP uses hours per dispatch, dispatch efficiency and a total revisit rate to compute an overall performance score, so that if a technician attempts to improve one component at the expense of the others, the ITP score can accurately reflect this in the technician's performance score.

### SUMMARY OF THE INVENTION

Some embodiments of the present invention can evaluate performance of a service technician who performs multiple service dispatches by comparing, in a computer system, the service technician's actual times to perform a series of tasks that comprise a dispatch, to planned times for the series of tasks. Accordingly, some embodiments of the present invention can assign a statistically derived planned time to tasks that make up a dispatch. By comparing the planned times versus the actual times, a detailed and objective work measurement may be provided.

More specifically, according to some embodiments of the present invention, performance of the service technician who performs multiple service dispatches is evaluated by decomposing a service dispatch into a series of tasks. Planned times are determined for tasks in the series. A comparison is made, in a computer system, between a service technician's actual times to perform the series of tasks to the planned times for the series of tasks. An evaluation of the service technician's performance is then generated in the computer system based upon the comparison.

In some embodiments, the service dispatch is performed at a customer premises, and at least some of the tasks include driving to the customer premises and driving from the customer premises. For these tasks, actual times for driving to the customer premises and driving from the customer premises may be determined based on data that is generated from a vehicle that is driven by the service technician. For example, Global Positioning System (GPS) data may be used. In other embodiments, the service technician begins daily dispatches from a service center and ends daily dispatches at the service center, and at least some of the tasks include performing beginning of day tasks at the service center and performing end of day tasks at the service center. In yet other embodiments, the planned times for tasks in the series are based on whether the tasks are being performed in a rural, suburban or urban location. In still other embodiments, a service dispatch is decomposed into a series of daily, job-based fixed and job-based variable tasks.

Moreover, in some embodiments of the present invention, an evaluation of the service technician's performance may include a comparison of total actual time worked in a day compared to total planned time for the day, based on service dispatches for the day. In other embodiments, a comparison of total number of demand service dispatches completed in a day compared to total number of demand service dispatches for the day also is generated. In yet other embodiments, an evaluation of the service technician's revision rate is generated based upon a number of service dispatches that are not completed on a first visit. Combinations and subcombinations of these embodiments also may be provided.

Finally, some embodiments of the present invention allow the performance evaluation to be performed on a daily basis. For example, the service technician's actual times to perform the series of tasks is compared to the planned times for the series of tasks, for dispatches in a given day, and an evaluation is generated of the service technician's performance for the given day. The evaluation is provided to a supervisor of the service technician at a beginning of the business day that immediately follows the given day.

It will be understood by those having skill in the art that, although embodiments of the invention have been described above primarily with respect to method aspects, analogous system and computer program products also may be provided. Other systems, methods, and/or computer program products according to embodiments of the present invention will be or become apparent to one of skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of systems, methods and/or computer program products according to some embodiments of the present invention.

FIG. 2 is a flowchart of operations that may be performed according to some embodiments of the present invention.

FIGS. 3 and 4 are block diagrams of other embodiments of the present invention.

FIG. 5 is a block diagram illustrating a Plain Old Telephone Service (POTS) loop that may be serviced according to some embodiments of the present invention.

FIGS. 6 and 7 illustrate an example of a fixed task and a variable task, respectively, for servicing a POTS loop of FIG. 5 according to some embodiments of the present invention.

FIG. 8 illustrates an example of tasks that may be applied to a service technician day according to some embodiments of the present invention.

FIG. 9. is a flowchart illustrating a calculation which may be used to evaluate a service technician's performance for a day, according to some embodiments of the present invention.

FIG. 10 illustrates an example that may be used to calculate planned times for dispatch 1: of FIG. 9.

FIG. 11 illustrates an example of a daily crew summary report that may be generated according to embodiments of the present invention.

FIG. 12 illustrates an example of a technician report that may be generated according to embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

As will be appreciated by one of skill in the art, the present invention may be embodied as a method, data processing system and/or computer program product. Thus, the present invention may take the form of an entirely hardware embodiment, an entirely software embodiment or an embodiment combining software and hardware aspects, which may be collectively referred to herein as a “module”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

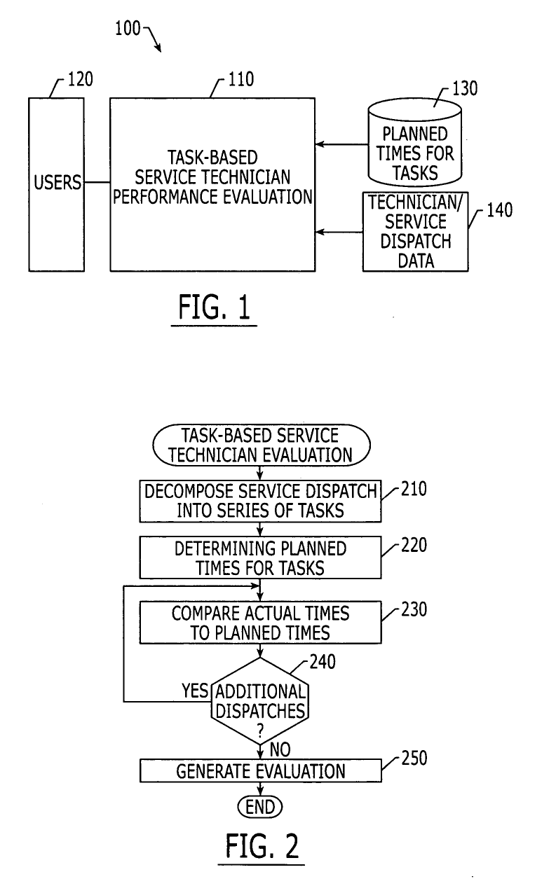

FIG. 1 is a block diagram of systems, methods and/or computer program products for evaluating performance of a service technician who performs multiple service dispatches. As shown in FIG. 1, these systems, methods and/or computer program products 100 include a task-based service technician performance evaluation module 110 that can be responsive to a stored set of planned times for tasks 130 and technician and/or service dispatch data 140, to compare a service technician's actual times to perform a series of tasks that comprise a dispatch, to planned times for the series of tasks. An evaluation of the service technician's performance may thereby be generated that can be provided to users 120, such as one or more managers of a service technician.

It will be understood by those having skill in the art that the task-based service technician performance evaluation module 110 may be embodied in a computer program product that runs on one or more enterprise, application, personal, pervasive and/or embedded computer systems that may be interconnected by a local and/or wide area network, such as the Internet. The database of planned times for tasks 130 may comprise a single database or a plurality of databases that may run on the same computer system as the task-based service technician performance evaluation module 110 and/or on a different computer system that may be connected thereto using a local and/or wide area network, such as the Internet. Moreover, the technician/service dispatch data 140 may be generated from multiple sources, as will be described in detail below, using one or more enterprise, application, personal, pervasive and/or embedded computer systems that may be connected to the task-based service technician performance evaluation module 110 using a local and/or wide area network including the Internet. Finally, the users 120 may be located at one or more user terminals that may be local to the task-based service technician performance evaluation module 110 and/or may be remotely connected thereto using a local and/or wide area network, such as the Internet.

FIG. 2 is a flowchart of operations that may be performed to obtain task-based service technician evaluations according to some embodiments of the present invention. These operations may be performed, for example, by the task-based service technician service evaluation module 110 of FIG. 1.

Referring now to FIG. 2, at Block 210, one or more service dispatches are decomposed into a series of tasks. For example, in some embodiments, the service dispatch is performed at a customer premises and at least some of the tasks comprise driving to the customer premises and driving from the customer premises. In other embodiments, the service technician begins daily dispatches from a service center and ends daily dispatches at the service center, and at least some of the tasks comprise performing beginning of day tasks at the service center and performing end of day tasks at the service center. In still other embodiments, planned times are determined based on whether the tasks are being performed in a rural, suburban or urban location. In yet other embodiments, the service dispatch is decomposed into a series of daily, job-based fixed and job-based variable tasks. These decompositions will be described in detail below.

Referring again to FIG. 2, at Block 220, planned times are determined for tasks in the series of tasks. Techniques for determining planned times will be described in detail below.

Still referring to FIG. 2, at Block 230, a service technician's actual times to perform the series of tasks are compared to planned times for the series of tasks. For example, actual times for driving to the customer premises and driving from the customer premises may be determined based on data such as GPS data that is generated from a vehicle that is driven by the service technician. Other examples will be described in detail below. If additional dispatches were performed by a service technician during the measurement time frame, at Block 240, then the operations of Block 230 are performed repeatedly.

Finally, at Block 250, an evaluation of the service technician's performance is generated in the computer system based on the comparison(s) of Block 230. For example, the evaluation may be generated by generating a comparison of total actual time worked in a day compared to total planned time for the day, based on service dispatches for the day. In other embodiments, a comparison of total number of demand service dispatches completed in a day, compared to total planned number of demand service dispatches for the day, may be generated. In still other embodiments, an evaluation of the service technician's revision rate may be generated based upon a number of service dispatches that are not completed on a first visit. Combinations and subcombinations of these embodiments also may be provided. Examples will be described below.

In some embodiments of the present invention, the operations of Blocks 230-250 may be performed periodically, for example, on a daily basis. Thus, in some embodiments of the present invention, the operations of Blocks 230 and 240 may be performed to compare the service technician's actual times to perform the series of tasks in a given day to the planned times for the series of tasks, and the operations of Block 250 may be performed to generate an evaluation of the service technician's performance for the given day. In these embodiments, the evaluation may be provided to a supervisor of the service technician, who may correspond to a user 120 of FIG. 1, at a beginning of a business day that immediately follows the given day. Daily coaching opportunities may thereby be provided. Accordingly, some embodiments of the present invention can provide management with detailed daily reports by consolidating data from other sources and objectively measuring efficiency by calculating planned times versus actual times.

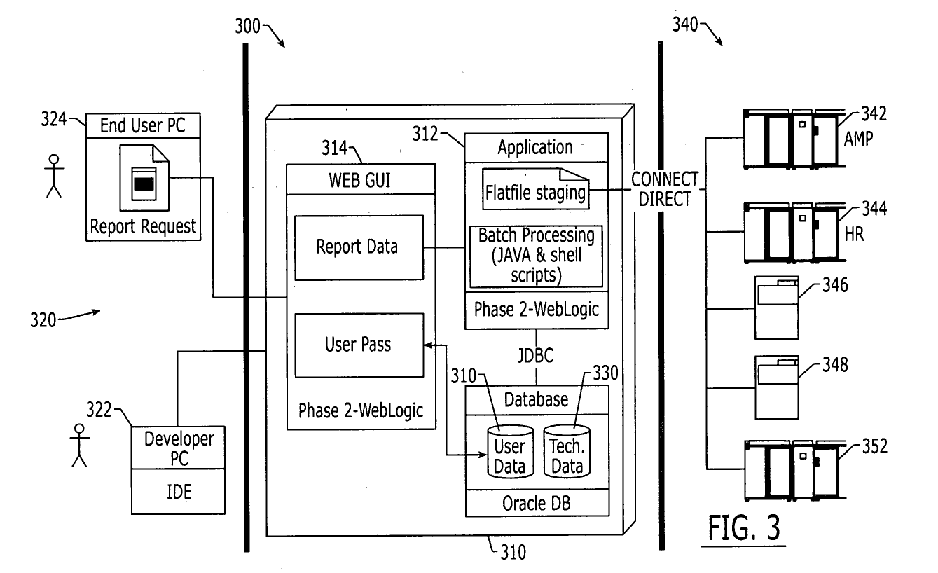

FIG. 3 is a functional block diagram of other embodiments of the present invention. As shown in FIG. 3, these systems, methods and/or computer program products 300 include a task-based service technician performance evaluation module 310 that may correspond to the task-based service technician performance evaluation module 110 of FIG. 1. A plurality of sources of technician/service dispatch data 340 may correspond to Block 140 of FIG. 1. A plurality of users 320 may correspond to the users 120 of FIG. 1. Finally, one or more databases 330 which include therein planned times for tasks, may correspond to the database 130 of FIG. 1.

More specifically, referring to FIG. 3, the task-based service technician performance evaluation module 310 can include an application module 312 that can provide staging and batch processing of the operations 230-250 of FIG. 2, for example on a daily basis. In some embodiments, reports from the previous day may be made available in the morning, for example at 7 AM, of the next business day. A Web Graphical User Interface (GUI) 314 can provide a Web-based interface to end users. The end users can include developers 322 who may access the system for testing and/or maintenance, and supervisors 324 of the service technicians. A users database 316 may contain an identification of authorized users so that access can be limited to authorized users.

Continuing with the description of FIG. 3, a plurality of sources of technicians/service dispatch data 340 may be provided. For example, an Activities Measurement Plan (AMP) system 342 may provide a data warehouse for work that has been performed by service technicians. The AMP system 342 may include data from a Mechanized Time Reporting (MTR) system that provides the number of hours worked. A Human Resource (HR) system 344 can provide human resources data on the service technicians. An Integrated Dispatch System (IDS) system 346 can provide data on dispatches and completion times. A GPS system 348 can provide vehicle movement times and distances, zone exit and entry times, windshield times, key-on/key-off times, stationary point exceptions, idle times and latitude/longitude data for the vehicle driven by the service technician. A technician access system 352 may provide customer billing information. The functionality and data provided by systems 342-352 are well known to those having skill in the art, and need not be described further herein.

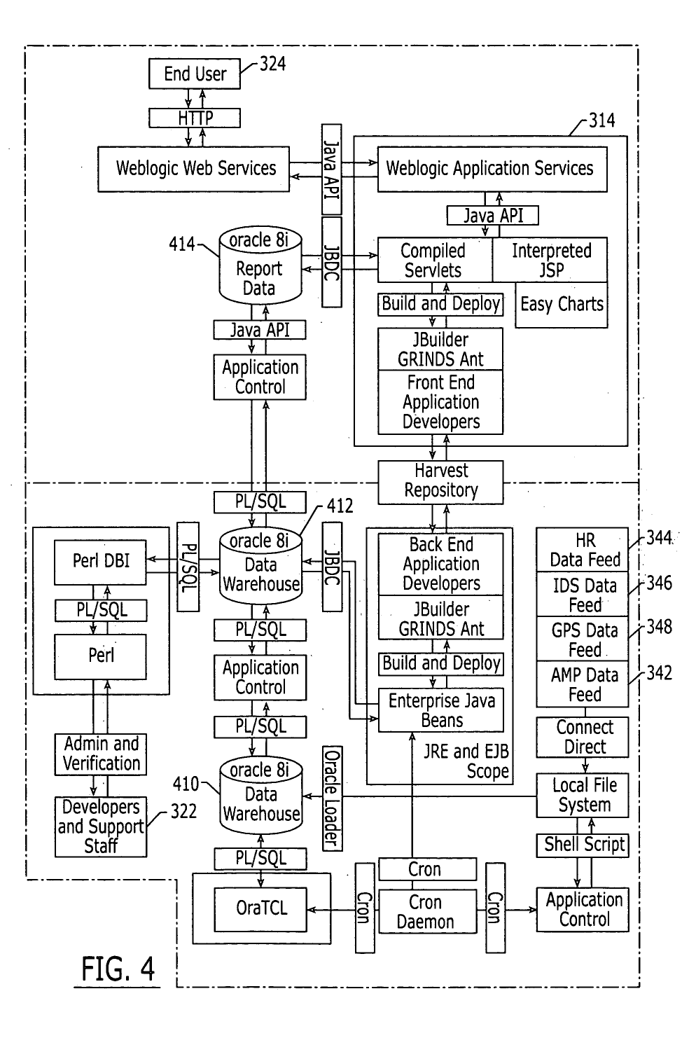

FIG. 4 is a detailed architectural block diagram of some embodiments of the present invention, illustrating details of an embodiment of a Web GUI 314 and its interfaces to end users 324, and storage of data feeds from an HR system 344, an IDS system 346, a GPS system 348 and an AMP system 342, in a plurality of databases and data warehouses. In particular, a data staging database 410 and a data warehouse database 412 can provide repositories for technician/service dispatch data 140, and a report data database can provide a repository for the evaluations or reports. The planned times for the tasks 130 may be stored in the data staging database 410. It will be understood by those having skill in the art that FIG. 4 illustrates specific enterprise computer system embodiments of the present invention. However, embodiments of the present invention need not be limited to the architectural view provided in FIG. 4.

Additional details according to some embodiments of the present invention now will be provided. In particular, additional details of the decomposing of a service dispatch into a series of tasks, which may correspond to Block 210 of FIG. 2, now will be provided. These details will be provided within the context of a communications service provider service technician who services Plain Old Telephone Service (POTS) loops. However, embodiments of the invention also are applicable to other service technicians. In particular, in some embodiments, a multiple-step process may be performed to decompose a service dispatch into a series of tasks. In a first step, tasks performed in the POTS loop may be classified by facility type and location. In a second step, a service technician's day may be separated into two categories: fixed and variable tasks. In a third step, prescribed methods for the fixed and variable tasks may be generated, documented and reviewed.

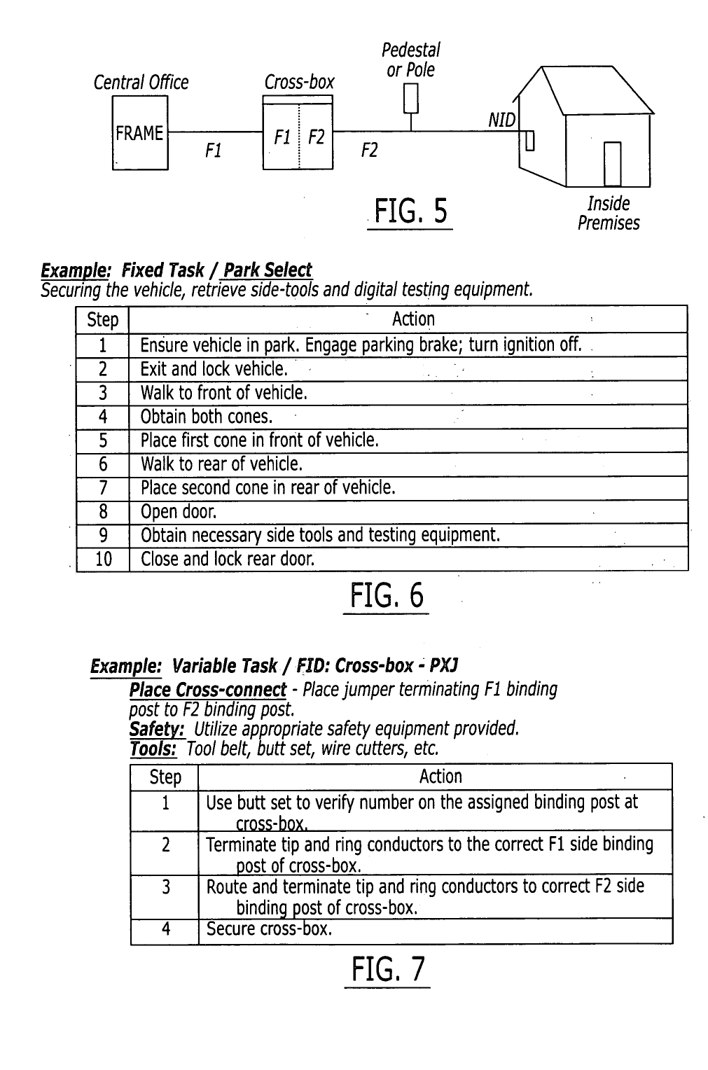

FIG. 5 conceptually illustrates an example of the first step to identify what tasks are performed at which facilities. For example, a POTS loop may include a central office, a cross-box, a pedestal or pole, a Network Interface Device (NID) and inside premises equipment.

In the second step, a service technician's day is separated into two categories: fixed and variable tasks. Fixed tasks include activities that occur routinely throughout the workday, regardless of the type of dispatch, such as walking, contacting the customer, entering or receiving data from a technician terminal, etc. Variable tasks include activities that are performed by a technician based on the particular service or repair activity that is being performed. The third step, prescribed methods for fixed and variable tasks were generated, reviewed and documented. FIG. 6 provides an example of a fixed task, i.e., the task of park select to secure a vehicle, retrieve side-tools and digital testing equipment. As shown, ten tasks are generated. FIG. 7 illustrates an example of a variable task, to place a jumper at a cross-box of FIG. 5.

Referring again to FIG. 2, at Block 220, planned times are determined for tasks. In some embodiments, certified observers can ride with technicians to capture the actual fixed and variable task-specific times. In some embodiments, over 3000 studies may be performed at a geographically widespread area in three work center classifications: rural, suburban and urban. The planned times may be tasks were grouped by type: daily, GPS-based, job-based fixed and job-based variable. Daily tasks are performed only once per day. GPS-based tasks are measured using GPS data. GPS contingency tasks may be used when GPS is unavailable. Job-based fixed tasks constitute time applied for each dispatch for walks, telephone calls, data entry, data retrieval from technician terminals, etc. Job-based variable tasks constitute time applied for each dispatch for actual repair services. Moreover, daily tasks can include AM and PM tasks which are performed once per day for each technician. AM can include the morning activities from start time to out of the gate of the service center, and PM can include the afternoon activities from back to the service center to end of day.

GPS-based tasks can include travel, park select and prepare. Travel can include GPS windshield time, park select can include a number of key-offs provided by GPS minus 3 (the key-offs for lunch and breaks), multiplied by a constant, such as 0.87. Prepare can include the number of key-ons provided by GPS minus 3 (the key-ons for lunch and breaks), multiplied by another constant, such as 0.96. Job-based fixed tasks can provide a measure of time for activities such as walks, customer contacts, phone calls, preparation of the technician terminal, etc. Job-based fixed tasks may be applied once per job according to each job's classification. In contrast, job-based variable tasks may be applied based on the repair or maintenance disposition code. Times may be applied based on specific task elements to complete various types of jobs. Once the element is identified, residential/business and density classification may be used to apply the correct time.

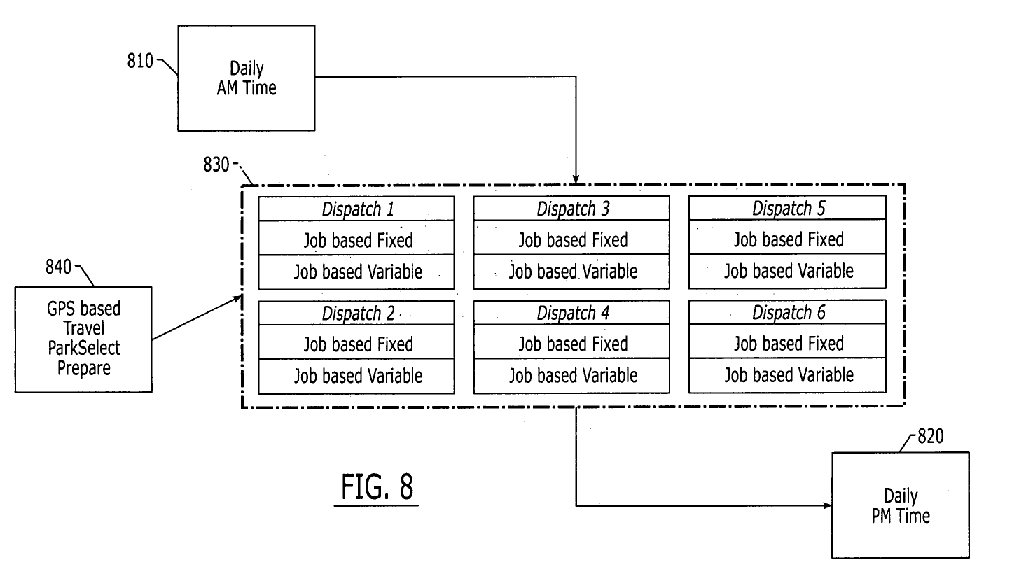

FIG. 8 provides an example of tasks that are applied to a technician day. As shown in FIG. 8, an AM time 810, a PM time 820 and a plurality of dispatch tasks 830 including fixed and variable tasks and GPS-based tasks 840 are applied for a plurality of dispatches.

Additional details on the generation of evaluations by comparing actual times to planned times, according to some embodiments of the present invention, which may correspond to Block 250 of FIG. 2, now will be provided. According to some embodiments of the present invention, an ITP score may be generated according to Equation 2:
ITP=% Performance Efficiency (0.5)+% Dispatch Efficiency (0.25)+(1−Total Revisit Rate)(0.25) (2),
where % Performance Efficiency, also referred to herein as % (Over/Under), provides a difference between how long a dispatch took versus how long it should have taken, based on planned times for the dispatch, and the remaining quantities were already defined with respect to Equation (1). As can be seen by a comparison of Equations (1) and (2), the combination of dispatch efficiency and revisit rate are provided a total of 50% weight in both formulas. In Equation (1), hours per dispatch is given a 50% weight, whereas in Equation (2), Performance Efficiency is given a 50% weight. Accordingly, Equation (2) defines performance efficiency based on actual versus planned times, whereas Equation (1) defines performance efficiency based on average hours per dispatch.

An example of a calculation of the percentage Over/Under of Equation (2) will now be provided according to some embodiments of the present invention. As an example, suppose a service technician completes six dispatches (two service and four troubles), wherein the total planned time is 5.45 hours and the actual time is 5.70 hours. Then, the Over/Under is 0.25 hours. Percentage Over/Under, also referred to herein as performance efficiency, may then be calculated as 5.45/5.70=95.6% performance efficiency.

An example of a calculation of a percent dispatch efficiency of Equation (2) now will be provided according to some embodiments of the present invention. Suppose a technician completes five of six jobs for a workday. Then, the jobs dispatched is equal to 6, the jobs completed is equal to 5, and the dispatch efficiency is equal to ⅚ or 83.3%.

Finally, an example calculation of the revisit rate of Equation (2) will be provided according to some embodiments of the present invention. The revisit rate provides a measurement of the percentage of jobs completed on the first visit to the customer location without the need for an additional visit. Stated otherwise, revisit rate determines service dispatches that are not completed successfully on a first visit. For example, if the service technician completes a job on a given day, and within the next eight days the same service technician and/or another service technician makes a visit, and this occurs five times in the month, then, if the number of jobs completed is 90 and the revisits charged is 5, the revisit rate is [1−(5/90)]×100 or 94.4%.

The following Table illustrates the calculation of a total ITP according to Equation (2), for three different service technicians.

TABLE

| | | | | Revisit Rate | |
|---|---|---|---|---|---|
| | Over/ | Performance | Dispatch | Efficiency | Total |
| | Under | Efficiency | Efficiency | 1-Rev | ITP |
| Tech 1 | −0.77 | 110.2% | 88.2% | 93.7% | 100.6% |
| Tech 2 | 0.29 | 96.2% | 88.4% | 87.7% | 92.1% |
| Tech 3 | 2.04 | 73.5% | 82.7% | 90.7% | 79.6% |

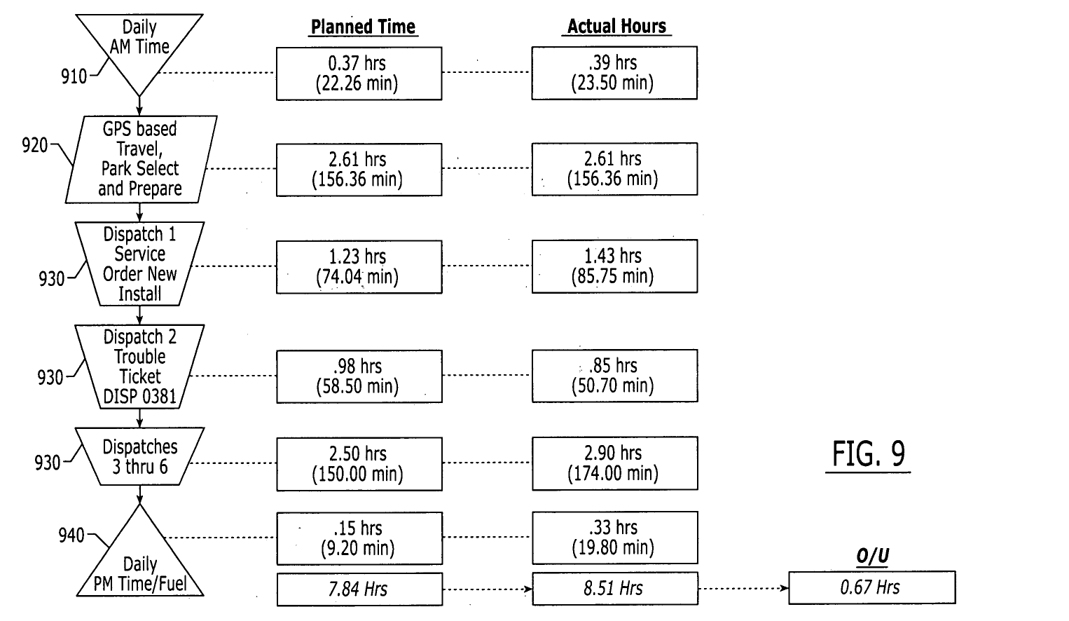

Referring again to FIG. 2, as shown at Blocks 230 and 240, planned and actual times for additional dispatches may be compared to obtain a total comparison for a given time period, such as a day. FIG. 9 is a flowchart that conceptually illustrates a calculation to evaluate a service technician's performance for a day according to some embodiments of the present invention. As shown in FIG. 9, a day includes an AM time 910, a GPS-based task time 920, a series of dispatch times 930, and a PM time 940. For each of these times, planned time versus actual hours may be computed and totaled, to arrive at Over/Under hours time of Equation (2).

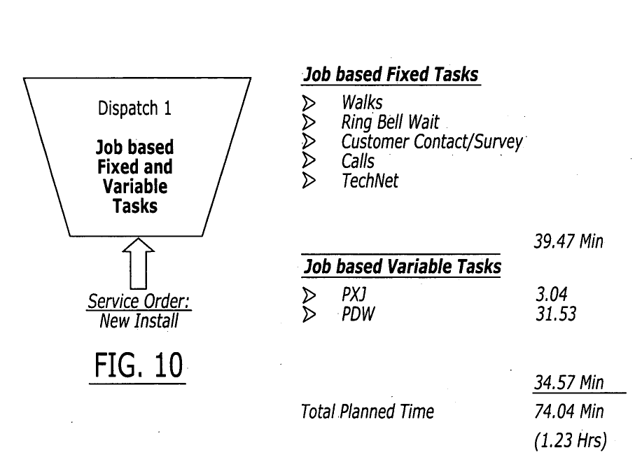

FIG. 10 illustrates an example that is used to calculate planned times for dispatch 1 of FIG. 9. As shown, job-based fixed tasks and job-based variable tasks may be totaled.

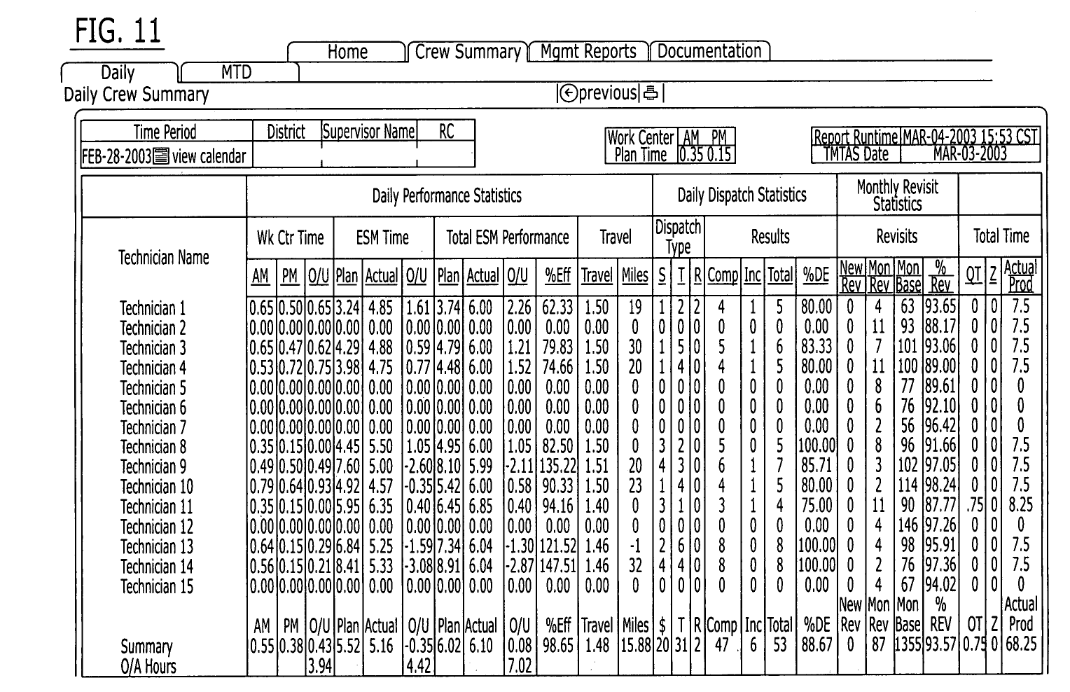

According to other embodiments of the present invention, evaluations may be generated in the form of a daily crew summary report, as illustrated in FIG. 11. The daily crew summary report of FIG. 11 can contain data on all technicians within a network manager's group. It can highlight daily statistics that are intended for the network manager as a quick look to determine coaching opportunities. As shown in FIG. 11, for each service technician, a total percentage performance efficiency (% Eff), a percentage dispatch efficiency (% DE), and a total repair revisit efficiency (% REV) is shown.

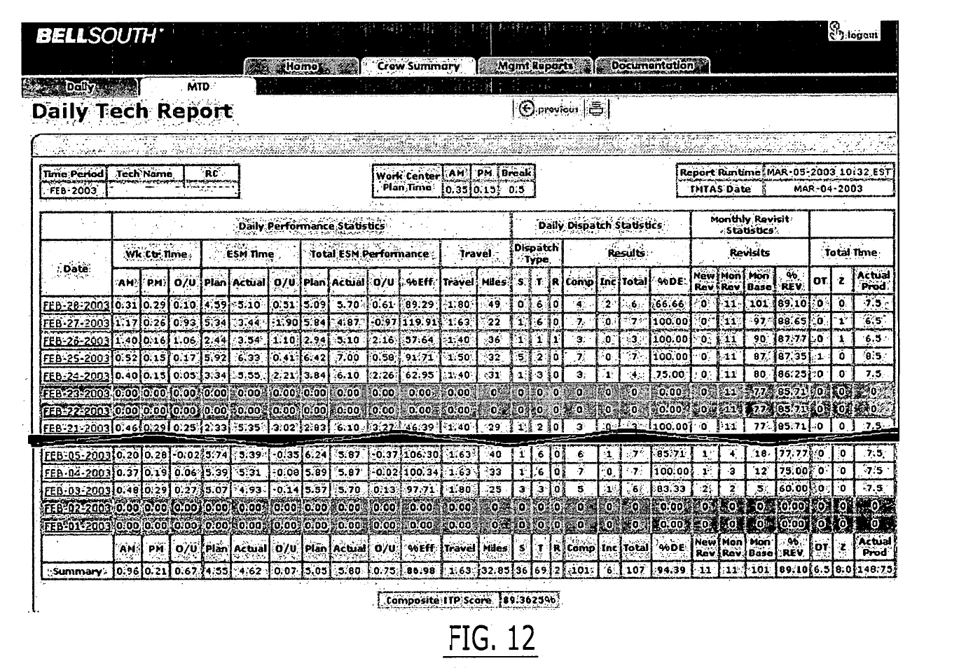

FIG. 12 illustrates a month to date technician report that can provide statistics similar to FIG. 11, for a technician, over a period of time, such as a current month. In FIG. 12, % Eff, % DE and % REV are shown as was the case in FIG. 11. FIG. 12 also illustrates a “Composite ITP Score” of 89.3625%, calculated per Equation 2.

Accordingly, some embodiments of the present invention can provide a scientific technique to measure performance by analyzing a task that constitutes a dispatch and calculating planned time based, for example, on location and/or density. Specific coaching opportunities may thereby be identified and immediate performance results may be provided.

In the drawings and specification, there have been disclosed embodiments of the invention and, although specific terms are employed, they are used in a generic and descriptive sense only and not for purposes of limitation, the scope of the invention being set forth in the following claims.

1. A computer-based method of evaluating performance of a service technician who performs multiple service dispatches, comprising:
decomposing a service dispatch into a series of tasks;
determining planned times for tasks in the series;
comparing, in a computer system, a service technician's actual times to perform the series of tasks to the planned times for the series of tasks; and
generating, in the computer system, an evaluation of the service technician's performance based upon the comparing.

2. A method according to claim 1 wherein the service dispatch is performed at a customer premises and wherein at least some of the tasks comprise driving to the customer premises and driving from the customer premises.

3. A method according to claim 2 wherein actual times for driving to the customer premises and driving from the customer premises are determined based on data that is generated from a vehicle that is driven by the service technician.

4. A method according to claim 1 wherein the service technician begins daily dispatches from a service center and ends daily dispatches at the service center and wherein at least some of the tasks comprise performing beginning of day tasks at the service center and performing end of day tasks at the service center.

5. A method according to claim 1 wherein the determining planned times for tasks in the series comprises determining planned times based on whether the tasks are being performed in a rural, suburban or urban location.

6. A method according to claim 1 wherein the decomposing a service dispatch into a series of tasks comprises decomposing a service dispatch into a series of daily, job-based fixed and job-based variable tasks.

7. A method according to claim 1 wherein the generating an evaluation comprises generating a comparison of total actual time worked in a day, compared to total planned time for the day, based on service dispatches for the day.

8. A method according to claim 7 further comprising:
generating, in the computer system, a comparison of total number of demand service dispatches completed in a day, compared to total number of demand service dispatches for the day.

9. A method according to claim 8 further comprising:
generating, in the computer system, an evaluation of the service technician's revision rate based upon a number of service dispatches that are not completed successfully on a first visit.

10. A method according to claim 1:
wherein the comparing comprises comparing the service technician's actual times to perform the series of tasks in a given day to the planned times for the series of tasks; and
wherein the generating comprises generating an evaluation of the service technician's performance for the given day based upon the comparing;
the method further comprising providing the evaluation to a supervisor of the service technician at a beginning of a business day that immediately follows the given day.

11. A computer-based method of evaluating performance of a service technician who performs multiple service dispatches, comprising:
comparing, in a computer system, a service technician's actual times to perform a series of tasks that comprise a dispatch, to planned times for the series of tasks.

12. A method according to claim 11 wherein the service dispatch is performed at a customer premises and wherein at least some of the tasks comprise driving to the customer premises and driving from the customer premises.

13. A method according to claim 12 wherein actual times for driving to the customer premises and driving from the customer premises are determined based on data that is generated from a vehicle that is driven by the service technician.

14. A method according to claim 11 wherein the service technician begins daily dispatches from a service center and ends daily dispatches at the service center and wherein at least some of the tasks comprise performing beginning of day tasks at the service center and performing end of day tasks at the service center.

15. A method according to claim 11 wherein the planned times for tasks in the series comprise planned times based on whether the tasks are being performed in a rural, suburban or urban location.

16. A method according to claim 11 wherein the series of tasks comprises a series of daily, job-based fixed and job-based variable tasks.

17. A method according to claim 11 wherein the comparing is performed daily based on the service technician's actual times to perform series of tasks for a previous business day.

18. A computer system for evaluating performance of a service technician who performs multiple service dispatches, comprising:
a module that is configured to compare a service technician's actual times to perform a series of tasks that comprise a dispatch, to planned times for the series of tasks.

19. A system according to claim 18 wherein the service dispatch is performed at a customer premises and wherein at least some of the tasks comprise driving to the customer premises and driving from the customer premises.

20. A system according to claim 19 wherein actual times for driving to the customer premises and driving from the customer premises are determined based on data that is generated from a vehicle that is driven by the service technician.

21. A system according to claim 18 wherein the service technician begins daily dispatches from a service center and ends daily dispatches at the service center and wherein at least some of the tasks comprise performing beginning of day tasks at the service center and performing end of day tasks at the service center.

22. A system according to claim 18 wherein the planned times for tasks in the series comprise planned times based on whether the tasks are being performed in a rural, suburban or urban location.

23. A system according to claim 18 wherein the series of tasks comprises a series of daily, job-based fixed and job-based variable tasks.

24. A system according to claim 18 wherein the module is configured to perform a daily comparison based on the service technician's actual times to perform series of tasks for a previous business day.

25. A system according to claim 18 wherein the module is further configured to generate an evaluation of the service technician's performance based upon the comparing.

26. A system according to claim 25 wherein the module is configured to generate an evaluation by generating a comparison of total actual time worked in a day, compared to total planned time for the day, based on service dispatches for the day.

27. A system according to claim 26 wherein the module is further configured to generate an evaluation by generating a comparison of total number of demand service dispatches completed in a day, compared to total number of demand service dispatches for the day.

28. A system according to claim 27 wherein the module is further configured to generate an evaluation by generating an evaluation of the service technician's revision rate based upon a number of service dispatches that are not completed successfully on a first visit.

29. A computer program product that is configured to evaluate performance of a service technician who performs multiple service dispatches, the computer program product comprising a computer usable storage medium having computer-readable program code embodied in the medium, the computer-readable program code comprising:
computer-readable program code that is configured to compare a service technician's actual times to perform a series of tasks that comprise a dispatch, to planned times for the series of tasks.

30. A computer program product according to claim 29 further comprising:
computer-readable program code that is configured to generate an evaluation of the service technician's performance, in response to the computer-readable program code that is configured to compare.
